(19) United States
(12) Patent Application Publication
(10) Pub. No.: US 2012/0172212 A1
(43) Pub. Date: Jul. 5, 2012

(54) Tri-layer structured metal oxides composite material and method for manufacturing the same

(76) Inventors: Jun Yue, Wuxi (CN); Xia Chu, Wuxi (CN); Liwei Jia, Wuxi (CN); Jianbin Ou, Wuxi (CN); Yang Liu, Wuxi (CN); Yun Zhang, Wuxi (CN); Pengfei Yu, Wuxi (CN); Xian Xu, Wuxi (CN); Jiaming Wang, Wuxi (CN); Dezhi Zeng, Wuxi (CN)

(21) Appl. No.: 12/408,700

(22) Filed: Mar. 21, 2009

(30) Foreign Application Priority Data
Mar. 21, 2008 (CN) 200810020034.1

(51) Int. Cl. B01J 21/06

(52) U.S. Cl. 502/304; 502/439

(57) ABSTRACT

The present invention disclosed a tri-layer structured metal composite oxides material which used in a catalyst coat for purifying vehicle exhaust gas, and the method for manufacturing the same.

### FIELD OF THE INVENTION

The present invention relates to a tri-layer structured metal composite oxides material which used in a catalyst coat for purifying vehicle exhaust gas, and the method for manufacturing the same.

### BACKGROUND OF THE INVENTION

The main content of vehicle exhaust gas is carbon monoxide (CO), hydrocarbon (HC) and nitrogen oxide (NOx). With a catalyst utilized in exhaustion system, CO & HC could be oxidized to carbon dioxide (CO₂) and water (H₂O); meanwhile, nitrogen oxide (NOₓ) could be deoxidized to nitrogen (N₂) in order to purify the vehicle exhaustion. This kind of catalyst is usually called as a three-way catalyst. A three-way catalyst contains two parts: a honeycombed ceramic carrier or a metal carrier, and a catalyst coat layer attached on the carrier. A catalyst coat is usually composed of oxide materials having a relatively large surface area, e.g., alumina, oxygen storage materials and the active components of noble metals, e.g., at least one kind among Platinum (Pt), Palladium (Pd), Rhodium (Rh), that disperse on the surface of oxide materials or oxygen storage materials. The oxygen storage materials are usually composite oxides containing cerium & zirconium that adjusts the ratio of oxidized components and deoxidized components in vehicle exhaustion by absorbing the oxygen from the exhaustion or releasing oxygen from itself through the process of CO and HC oxidization and simultaneous deoxidization of NOₓ.

In order to improve the HO conversion efficiency during a vehicle cold start, a three way catalyst is usually placed on a location close to the engine manifold exhaustion pipe exit. When a vehicle runs at high speeds, the temperature of catalyst's coat layer could reach approximately between 900° c and 1100° c. Under such high temperatures, the catalyst coat materials can be charred and then its surface area is reduced and oxygen storage capacity is weakened. The noble metal grains that disperse on its surface gradually aggregate and become embedded into the collapsed tunnel caused by sinter. Consequently, the active area on catalyst surface decreases and the conversion efficiency of CO, HO and NOₓ is lowered. Moreover, under the high temperature and with sufficient oxygen, the noble metal Rhodium (Rh) alloys with alumina (γ-Al₂O₃) and cerium bioxide (CeO₂) in the coat layer. The process decreases the efficiency of the catalysis of Rhodium (Rh) as well.

The current technology prepares the three way catalyst coat layer by mixing the powders of alumina (γ-Al₂O₃) and oxygen storage materials physically and subsequent grinding by a ball mill with other auxiliary agents. The coat layer materials prepared this way are unstable under high temperatures. The surface area is relatively small after ten-hour high temperature aging process under between 900° c and 1100° c. In addition, the three-way catalyst with the coat layer covered with noble metal interacts poorly with CO, HO and NOₓ after the high temperature aging process. Furthermore, the process uses cerium and zirconium composite oxide powders with large particle sizes and the oxygen storage process mainly takes place on the surface of cerium and zirconium composite oxide particles while buried part of the particles could not store oxygen. In order to improve the three way catalyst efficiency, metal composite oxides material used in three way catalyst coat and method for manufacturing the same had been published. For example, U.S. Pat. No. 6,576,207 by Degussa Company discloses a method of co-precipitation to disperse cerium and zirconium composite oxide nano particles on the surface of γ-Al₂O₃ powders which have high specific surface area to form a double-layer structure in order to improve material stability under high temperatures and dynamic oxygen storage efficiency of cerium and zirconium composite oxide; similarly, US Patent Application No. US2007179054 from Mazda Company discloses a reverse co-precipitation method to disperse cerium and zirconium composite oxide nano particles on the surface of γ-Al₂O₃ powder to form a double-layer structure. Generally speaking, cerium and zirconium composite oxide with rich cerium is better in oxygen storage capability than cerium and zirconium composite oxide with rich zirconium, but the former has a weaker thermo-stability is weaker than the latter. Therefore, the double-layer structure from afore-mentioned patent application publication has such a shortage: cerium and zirconium oxygen storage material on surface could not meet the requirement of oxygen storage capability and thermo stability at the same time.

### SUMMARY OF THE INVENTION

An object of the present invention is to overcome the shortage of existing technology, and to provide a tri-layer structured metal composite oxides material having improved thermo stability and pollution treatment capability.

Another object of the present invention is to provide a method of preparing afore-mentioned tri-layer structured metal composite oxides material.

According to one embodiment of the present invention, a metal composite oxides material has a tri-layer structure characterized by: an inner layer that is alumina, a middle layer and an outer layer both are cerium and zirconium oxide adulterated with rare earth in which cerium oxide has been removed, when a Ce/Zr atomic ratio in cerium and zirconium composite oxide of outer layer is ≧1, a Ce/Zr atomic ratio in cerium and zirconium composite oxide of middle layer is ≦1/3; and when a Ce/Zr atomic ratio in cerium and zirconium composite oxide of outer layer is ≦1/3, a Ce/Zr atomic ratio in cerium and zirconium composite oxide of middle layer is ≧1.

Mass ratio of inner alumina and middle layer is 10:5˜10:1.

Mass ratio of middle layer and outer layer is 1:3˜4:1

Mass weight of Cerium oxide removed rare earth in cerium and zirconium composite oxide is 2%˜10%

The method of preparing tri-layer structured metal composite oxides material in present invention comprising below steps:

First step: dissolving Ce³⁺, Zr⁴⁺ and adulterated rare earth in deionized water,

wherein the atomic ratio of Ce³⁺, Zr⁴⁺ and adulterated rare earth is the same as that in the middle layer, then mixing with citric acid aqueous solution, stirring to form complex solution of metal iron and citric acid, in solution in which a molar concentration of citric acid ≧(3× molar concentration of Ce³⁺+4× molar concentration of Zr⁴⁺)/3, adding alumina powder having a particle size of 90 μm and specific surface area ≧130 m2/g into complex solution to form suspension solution, then evaporating to dryness the suspension solution under temperature between 60˜100° C., desiccating for 5˜12 hour under temperature between 120˜200° C., baking for 3˜6 hour under temperature between 450° C.˜650° C., and rubbing the baked power to obtain a double-layer structured powder in which a mass ratio of alumina in inner layer and cerium and zirconium composite oxide adulterated with rare earth on surface is 10:5˜10:1.

Second step: dissolving Ce³⁺, Zr⁴⁺ and adulterated rare earth in deionized water, wherein the atomic ratio of Ce³⁺, Zr⁴⁺ and adulterated rare earth is the same as that in the outer layer, then mixing with citric acid aqueous solution, stirring to form complex solution of metal iron and citric acid, in solution in which a molar concentration of citric acid (3× molar concentration of Ce³⁴ plus 4× molar concentration of Zr⁴⁺)/3, adding the double-layer structured powder prepared by first step into complex solution to form suspension solution, the particle size of mentioned powder is 2 μm˜60 μm, evaporating to dryness the suspension solution under temperature between 60° C. and 100° C., desiccating for 5˜12 hour under temperature between 120° C. and 200° C., baking for 3˜6 hour under temperature between 450° C.˜650° C., and rubbing the baked power to obtain a tri-layer structured metal composite oxides powder.

A noble metal catalyst used for purifying vehicle exhaust gas comprising the tri-layer structured metal composite oxides material. The present invention has following characterization:

(1) Cerium and zirconium composite oxide nano crystal particles are dispersed directly on surface of alumina particle having large specific surface area by Sol-Gel method, instead of being mixed physically cerium and zirconium oxide powder with alumina powder. On the one hand, high dispersion of cerium and zirconium oxide on the surface of alumina particle improves the surface of cerium and zirconium oxide, and restrain accretion of cerium and zirconium oxide crystal particle under high temperature; on the other hand, dispersion of cerium and zirconium oxide on surface of alumina particle could fully exert the capability of oxygen storage.

(2) Alumina is the inner layer of tri-layer structure, the contact of alumina particle will be difficult by separation of middle layer and outer layer, thus increase the thermo stability of alumina.

(3) Ce/Zr atomic ratio of cerium and zirconium oxide in middle layer and in outer layer is different, which could be chosen by application of catalyst: when the noble metal carried on metal composite oxides surface is Pd, the catalyst which outer layer cerium and zirconium oxide has Ce/Zr atomic ratio ≧1 is more efficient on HC and CO conversion than those catalyst which outer layer cerium and zirconium oxide has Ce/Zr atomic ratio ≦1, and cerium and zirconium oxide in middle layer whose Ce/Zr atomic ratio ≦1/3 could improve the stability of outer layer and catalyst under high temperature; when the noble metal carried on metal oxide surface is Rh, Ce/Zr atomic ratio of cerium and zirconium oxide in outer layer ≦1/3 will restrain Rh alloy with Ce under the condition of rich oxygen and high temperature, cerium and zirconium oxide whose Ce/Zr atomic ratio used in the middle layer could improve oxygen storage capability of catalyst.

### DETAILED DESCRIPTION OF THE PREFERRED EMBODIMENTS

Further explanation to the present invention will be described in combination with specific examples.

### Example 1

Step 1: dissolve 500 g citric acid in 500 g deionized water to obtain 1000 g citric acid solution, and dissolve 214 g ZᵣO(NO₃)₂.5H₂O, 434 g Ce(NO₃)₃.6H₂O and 35.5 g La(NO₃).6H₂O in 600 g deionized water to obtain another solution. Mix two solutions and stir for 1 hour, add 1337 g alumina powder (particle size is 90 μm and specific surface area is 150 m²/g) to obtain a suspension solution. Then heat the suspension solution to 80° C., stir the solution till it dry up, desiccate the residue for 12 hour at 120° C., then bake 5 hour at 600° C., and mill the cool baked powder to obtain a double-layer structured light yellow powder, i.e., powder 1, in which a mass ratio of alumina I cerium and zirconium oxide is 5:1, a Ce/Zr ratio of cerium and zirconium oxide is 3/2, and a weight ratio of La₂O₃ in cerium and zirconium oxide is 5%.

Step 2: dissolve 500 g citric acid in 500 g deionized water to obtain 1000 g citric acid solution, dissolve 491 g ZrO(NO₃)2.5H₂O, 166 g Ce(NO₃)₃.6H₂O and 35.5 g La(NO₃).6H₂O in 600 g deionized water to obtain another solution, mix the two solutions and stir for 1 hour, add 1337 g powder 1 to obtain a suspension solution. Then heat the suspension solution to 80° C., stir the solution till it dry up, desiccate the residue for 12 hour at 120° C., then bake 5 hour at 600° C., and mill the cool baked powder to obtain a tri-layer structured metal composite oxides powder, i.e., powder 3, in which a mass ratio of alumina/cerium and zirconium oxide in middle layer is 5:1, a mass ratio of cerium and zirconium oxide in middle layer/cerium and zirconium oxide in outer layer is 1:1, a Ce/Zr ratio of cerium and zirconium oxide in middle layer is 3/2, a weight ratio of La₂O₃ is 5%; a Ce/Zr of cerium and zirconium oxide in outer layer is 1/4, a weight ratio of La₂O₃ is 5%.

### Example 2

Step 1: dissolve 500 g citric acid in 500 g deionized water to obtain 1000 g citric acid solution, dissolve 491 g ZrO(NO₃)₂.5H₂O, 166 g Ce(NO₃)₃.6H₂O and 35.5 g La(NO₃).6H₂O in 600 g deionized water to obtain another solution, mix two solutions and stir for 1 hour, add 1337 g alumina powder (particle size is 45 μm and specific surface area is 150 m²/g) to obtain a suspension solution. Then heat the suspension solution to 80° C., stir the solution till it dry up, desiccate the residue for 12 hour at 120° C., bake 5 hour at 600° C., and then mill the cool baked powder to obtain a double-layer structured light yellow powder, i.e., powder 2, in which a mass ratio of alumina/cerium and zirconium oxide is 5:1, a Ce/Zr ratio of cerium and zirconium oxide is 1/4, a weight ratio of La₂O₃ in cerium and zirconium oxide is 5%.

Step 2: dissolve 500 g citric acid in 500 g deionized water to obtain 1000 g citric acid solution, dissolve 214 g ZrO(NO₃)₂.5H₂O, 434 g Ce(NO₃)₃.6H₂O and 35.5 g La(NO₃).6H₂O in 600 g deionized water to obtain another solution, mix two solutions and stir for 1 hour, add 1337 g powder 2 to obtain a suspension solution. Then heat suspension solution to 80° C., stir the solution till it dry up, desiccate the residue for 12 hour at 120° C., then bake 5 hour at 600° C., and mill the cool baked powder to obtain a tri-layer structured metal composite oxides powder, i.e., powder 4: in which a mass ratio of alumina/cerium and zirconium oxide in middle layer is 5:1, a mass ratio of cerium and zirconium oxide in the middle layer/cerium and zirconium oxide in outer layer is 1:1, a Ce/Zr ratio of cerium and zirconium oxide in middle layer is 1/4, a weight ratio of La₂O₃ is 5%; a Ce/Zr ratio of cerium and zirconium oxide in outer layer is 3/2, a weight ratio of La₂O₃ is 5%.

### Example 3

### The preparation of Three Way Catalyst A (Rh-Powder 2/Pd-Powder 1/Ceramic Carrier)

Pd coat: Powder 1 is mixed with deionized water uniformly, drop Pd(NO₃)₃ solution slowly, ball mill this suspension solution to obtain a slurry I which has average particle size of 50 μm and solids content of 45%. Coat a certain amount of slurry I on honeycombed ceramic carrier whose is φ20 mm×40 mm, and 400 cpsi/6.5 mil (volume 12.56 ml), then dry and bake it.

Rh coat: Powder 2 is mixed with deionized water uniformly, drop Rh(NO₃)₃ solution slowly, ball mill this suspension solution to obtain slurry II which has average particle size of 50 μm and solids content of 40%. Coat a certain amount of slurry II on carrier which already coated by Pd, then dry and bake it, thereby obtain a three way catalyst A: Rh-powder 2/Pd-powder 1/ceramic carrier that comprise the below components.

| | φ20 mm × 40 mm, |
|---|---|
| Carrier | 400 cpsi/6.5 mil |
| Powder 1 | 70 g/L |
| Powder 2 | 50 g/L |
| Pd | 30 g/ft³ |
| Rh | 6 g/ft³ |
| [symbol] 1 | 70 g/L |
| [symbol] 2 | 50 g/L |
| Pd | 30 g/ft³ |
| Rh | 6 g/ft³ |

### Example 4

### The Preparation of Three Way Catalyst B (Rh-Powder 3/Pd-Powder 4/Ceramic Carrier)

The preparation process is the same as the process of preparing catalyst A, except powder 4 is replaced with powder 1 and powder 3 is replaced with powder 2. Catalyst B comprises the below components.

| | φ20 mm × 40 mm, |
|---|---|
| Carrier | 400 cpsi/6.5 mil |
| Powder 4 | 70 g/L |
| Powder 3 | 50 g/L |
| Pd | 30 g/ft³ |
| Rh | 6 g/ft³ |

### Example 5

### The Preparation of Three Way Catalyst C (Rh-Powder 4/Pd-Powder 3/Ceramic Carrier)

The preparation process is the same as the process of preparing catalyst A, except powder 3 is replaced with powder 1 and powder 4 is replaced with powder 2. Catalyst C comprises the below components.

| | φ20 mm × 40 mm, |
|---|---|
| Carrier | 400 cpsi/6.5 mil |
| Powder 3 | 70 g/L |
| Powder 4 | 50 g/L |
| Pd | 30 g/ft³ |
| Rh | 6 g/ft³ |

### Example 6

### Catalysis Performance Evaluation of Catalyst A-C

Before conduct catalysis performance test, all catalyst had been aging for 20 hour in 10 volume % H₂O/90% air at 1050° C. Using simulate evaluation system to test the performance of catalyst. Test objects are light-off temperature T50 (catalyst inlet temperature correspond to contamination conversion reach 50%) and dynamic conversion at 450° C. of HC, CO and NOₓ, below table show the composition of synthesis gas in a simulate evaluation system while test inlet temperature.

| Composition | Composition | Composition | Composition |
|---|---|---|---|
| C₃H₆ | 333 ppm | O₂ | 1.15 vol. % |
| C₃H₆ | 167 ppm | CO₂ | 14 vol. % |
| CO | 1.5 vol. % | H₂O | 10 vol. % |
| H₂ | 0.5 vol. % | N₂ | balance gas |
| NOₓ | 1000 ppm | | |

| | |
|---|---|
| LambdaValue | 0.998 |

Inlet temperature of catalyst gradually raise to 500° C. in speed of 60° C./min, air speed of synthesis gas is 60000 h⁻¹, the value of light-off temperature T50 showing in below table

| | HC T50/ | CO T50/ | NOx T50/ |
|---|---|---|---|
| Catalyst | ° C. | ° C. | ° C. |
| A | 314 | 293 | 297 |
| B | 306 | 286 | 288 |
| C | 312 | 290 | 296 |

Keep catalyst Inlet temperature at 450° C. while test dynamic conversion, Lambda Value of synthesis gas is 0.998±0.03, surge frequency is 1 HZ, the value of dynamic conversion showing in below table

| | Conversion | Conversion | Conversion |
|---|---|---|---|
| Catalyst | of HC % | of CO/ % | of NOₓ/ % |
| A | 84 | 90 | 87 |
| B | 92 | 95 | 94 |
| C | 88 | 93 | 89 |

Catalyst performance evaluation result indicates that after aging in hot water at 1050° C., catalyst B has the highest catalysis efficiency. Compared with Catalyst A which prepared by double-layer structured metal composite oxides, three kinds of infectant treated by catalyst B and C will have higher conversion and lower light-off temperature. The contrast between catalyst B and catalyst C shows that while it carry different noble, the chose of Ce/Zr of cerium and zirconium oxide in middle layer and outer layer among metal composite oxides will effect the high temperature stability.

What we claim are:

1. A tri-layer structured metal composite oxides material, wherein the metal composite oxides material has tri-layer structure, the inner layer is alumina, the middle layer and outer layer both are cerium and zirconium oxide, the cerium and zirconium oxide adulterates with rare earth in which cerium oxide had been removed, when a Ce/Zr atomic ratio in cerium and zirconium composite oxide of outer layer is ≧1, a Ce/Zr atomic ratio in cerium and zirconium composite oxide of middle layer is ≦1/3; and when a Ce/Zr atomic ratio in cerium and zirconium composite oxide of outer layer is ≦103, a Ce/Zr atomic ratio in cerium and zirconium composite oxide of middle layer is ≧1.

2. The tri-layer structured metal composite oxides material of claim 1, wherein the mass ratio of inner alumina and middle layer is 10:5˜10:1.

3. The tri-layer structured metal composite oxides material of claim 1, wherein the mass ratio of middle layer and outer layer is 1:3˜4:1.

4. The tri-layer structured metal composite oxides material of claim 1, wherein the weight of cerium oxide removed rare earth in cerium and zirconium oxide is about 2%˜10%.

5. A method for manufacturing the tri-layer structured metal composite oxides material of any one of claims 1 to 4 comprising:
First step: dissolving Ce³⁺, Zr⁴⁺ and adulterated rare earth in deionized water, wherein the atomic ratio of Ce³⁺, Zr⁴⁺ and adulterated rare earth is the same as that in the middle layer, then mixing with citric acid aqueous solution, stirring to form complex solution of metal iron and citric acid, in solution in which a molar concentration of citric acid ≧(3× molar concentration of Ce³⁺+4× molar concentration of Zr⁴⁺)/3, adding alumina powder having a particle size of 90 μm and specific surface area ≧130 m2/g into complex solution to form suspension solution, then evaporating to dryness the suspension solution under temperature between 60˜100 C, desiccating for 5˜12 hour under temperature between 120˜200 C, baking for 3˜6 hour under temperature between 450˜650 C, and rubbing the baked power to obtain a double-layer structured powder in which a mass ratio of alumina in inner layer and cerium and zirconium composite oxide adulterated with rare earth on surface is 10:5˜10:1;
Second step: dissolving Ce³⁺, Zr⁴⁺ and adulterated rare earth in deionized water, wherein the atomic ratio of Ce³⁺, Zr⁴⁺ and adulterated rare earth is the same as that in the outer layer, then mixing with citric acid aqueous solution, stirring to form complex solution of metal iron and citric acid, in solution in which a molar concentration of citric acid (3× molar concentration of Ce³⁺+4× molar concentration of Zr⁴⁺)/3, adding the double-layer structured powder prepared by first step into complex solution to form suspension solution, the particle size of mentioned powder is 2 μm˜60 μm, evaporating to dryness the suspension solution under temperature between 60˜100 C. desiccating for 5˜12 hour under temperature between 120˜200 C, baking for 3˜6 hour under temperature between 450˜650 C, and rubbing the baked power to obtain a tri-layer structured metal composite oxides powder.

6. A noble metal catalyst used for purifying vehicle exhaust gas comprising the tri-layer structured metal composite oxides material of claim 1.
